(19) United States
(12) Patent Application Publication
(10) Pub. No.: US 2004/0068551 A1
(43) Pub. Date: Apr. 8, 2004

(54) Method of accessing content data on a wireless device

(76) Inventors: James Hymel, Lake Worth, FL (US); Thomas A. Larotonda, Parkland, FL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/266,852

(22) Filed: Oct. 8, 2002

(51) Int. Cl. G06F 15/16

(52) U.S. Cl. 709/217

(57) ABSTRACT

A method of accessing content data (276) on a wireless device (202), includes collecting a content element (207) corresponding to a secondary channel (211) and content (277) broadcast on the secondary channel, and wherein the content element comprises a corresponding content link (290). A user preference (274) is matched to the content element. In a primary channel cell area (222), the wireless device scans for the secondary channel, and a user creates a listening location profile (242). A user selects the secondary channel to be included in the listening location profile, where the listening location profile corresponds to the primary channel cell area. Using the primary channel, the listening location profile and the user preference, content data corresponding to the content element on the secondary channel in the listening location profile is accessed.

### BACKGROUND OF THE INVENTION

Many cellular phones are equipped with radio receivers to offer the user a large array of communication and entertainment choices within a small wireless package. An ever increasing number of radio stations are publishing their play-lists, which can include artists, station genre, song, time/date, radio frequency, and the like. Also, many elements in the play-lists include Uniform Resource Locator (URL) information to support ecommerce transactions. This vast array of information and choices can overwhelm a user of a wireless device equipped with both a cellular transceiver and a radio receiver. The prior art is lacking in a method of allowing a user to efficiently and geographically manage content using a wireless device so equipped.

Accordingly, there is a significant need for an apparatus and method that overcomes the disadvantages of the prior art outlined above.

### BRIEF DESCRIPTION OF THE DRAWINGS

Referring to the drawing:

FIG. 1 is a block diagram of a communications system in accordance with an embodiment of the invention;

FIG. 2 is block diagram of a communications system in accordance with another embodiment of the invention;

FIG. 3 is a ladder diagram in accordance with an embodiment of the invention;

FIG. 4 is a flow diagram in accordance with an embodiment of the invention;

FIG. 5 is a flow diagram in accordance with another embodiment of the invention; and

FIG. 6 is a flow diagram in accordance with still another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings (where like numbers represent like elements), which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical, electrical, or logical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

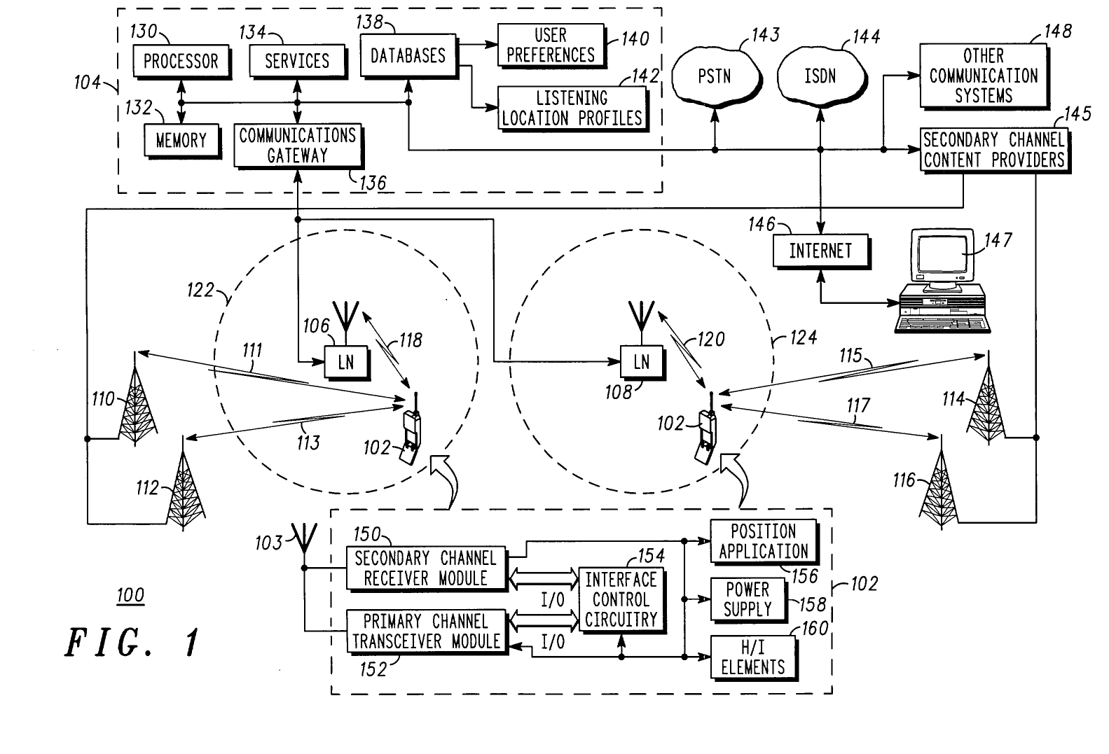

FIG. 1 is a block diagram of a communications system 100 in accordance with an embodiment of the invention. As shown in FIG. 1, communications system 100 includes wireless device 102, which can include, without limitation, a wireless unit such as a cellular or Personal Communication Service (PCS) telephone, a pager, a hand-held computing device such as a personal digital assistant (PDA) or Web appliance, or any other type of communications and/or computing device. Without limitation, one or more wireless devices 102 can be contained within, and optionally form an integral part of a vehicle, such as a car, truck, bus, train, aircraft, or boat, or any type of structure, such as a house, office, school, commercial establishment, and the like. In an embodiment of the invention, a user can carry wireless device 102.

In an embodiment, wireless device 102 has a common antenna 103, which feeds primary channel transceiver module 152 and secondary channel receiver module 150. Both primary channel transceiver module 152 and secondary receiver module 150 can share power supply 158 and communicate with interface control circuitry 154. Primary channel transceiver module 152 is capable of sending and receiving content to and from local node 106, 108 of communications system 100 via wireless links of primary channel 118, 120. In an embodiment, a primary channel can include wireless communication taking place using a cellular network, paging network, satellite networks, and the like.

In an example of an embodiment, primary channel 118, 120 can include narrowband and/or broadband communications with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. Primary channel 118, 120 can also include messaging protocols such Short Message Service Cell Broadcast (SMSCB), General Packet Radio Service (GPRS), and the like.

Wireless device 102 can also include position application 156, which can include any number of position sources, devices and software elements designed to determine a location of wireless device 102. Examples of sources and devices, without limitation, include global positioning system (GPS), differential GPS, a kiosk (fixed position source), and enhanced observed time difference (EOTD), which comprise terrestrial cellular triangulation, and the like.

Wireless device 102 can include human interface (H/I) elements 160, which can comprise elements such as a display, a multi-position controller, one or more control knobs, one or more indicators such as bulbs or light emitting diodes (LEDs), one or more control buttons, one or more speakers, a microphone, and any other H/I elements required by wireless device 102. H/I elements 160 can request and display content and data including, application data, position data, personal data, email, audio/video, and the like. The invention is not limited by the (H/I) elements described above. As those skilled in the art will appreciate, the (H/I) elements outlined above are meant to be representative and to not reflect all possible (H/I) elements that may be employed.

Communications system 100 can also include content matching system 104, which is coupled to local nodes 106, 108 via a service provider (not shown for clarity). Content matching system 104 can include a processor 130 for processing algorithms stored in memory 132. Memory 132 comprises control algorithms, and can include, but is not limited to, random access memory (RAM), read only memory (ROM), flash memory, electrically erasable programmable ROM (EEPROM), and the like. Memory 132 can contain stored instructions, tables, data; and the like, to be utilized by processor 130.

Content matching system 104 can also include services 134, which can be located at content matching system 104, distributed between content matching system 104 and other communications systems 148, and the like. A service 134 can be an encapsulation of some functionality that is of use to one or more service-using entities (current or anticipated) or that needs to be isolated from the service-using entity for some reason. A service 134 can provide access to information or perform some computation. Services 134 also provide a desired functionality of a human user, such as applications, an on-board global positioning system (GPS) device, games, email, and the like.

Content matching system 104 can also include communications gateway 136, which comprises one or more network access devices (NAD's) that can utilize narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used.

Databases 138 can include a hard drive, floppy disk drive, optical drive, CD-ROM, RAM, ROM, EEPROM, or any other means of storing content, which can be utilized by content matching system 104. In the embodiment depicted in FIG. 1, databases 138 function to store, among other things, user preferences in a user preference database 140 and listening location profiles stored in listening location profiles database 142. However, database 138 is not limited to these functions, and other databases are within the scope of the invention.

Content matching system 104 can be coupled to a public switched telecommunication network (PSTN) 143, Internet 146, an integrated services digital network (ISDN) 144, satellites, local area networks (LAN's), wide area networks (WAN's) other communications systems 148, and the like. Content matching system 104 can be coupled to any number of local nodes 106, 108, which provide wireless communication to and from wireless device 102 via wireless communication links over primary channel 1118, 120.

Local nodes 106, 108 each have a primary channel cell area 122, 124, inside of which communication between content matching system 104 and wireless device 102 can take place. As an example of an embodiment of the invention, local node 106 has primary channel cell area 122, and local node 108 has primary channel cell area 124. In an embodiment, primary channel cell areas 122, 124 can overlap. In another embodiment, primary channel cell areas 122, 124 do not overlap. Primary channel cell areas 122, 124 can vary in size depending on conditions, for example, number of wireless devices 102 communicating with local node 106, 108 (loading), topography, weather conditions, obstructions between local node 106, 108 and wireless device 102, and the like.

Communications system 100 can also include any number of secondary channel stations 110, 112, 114, 116. Secondary channel stations 110, 112, 114, 116 can include commercial radio stations, for example and without limitation, AM radio stations and sub-carriers, FM radio stations and sub-carriers, and the like. Content can be pushed to wireless device 102 over secondary channels 111, 113, 115, 117, which are separate from primary channels 118, 120. Secondary channel stations 110, 112, 114, 116 and secondary channels 111, 113, 115, 117 are not limited to AM or FM stations, sub-carriers and frequencies, and other secondary channel bands are included in the invention.

As shown in FIG. 1, wireless device 102 located in a primary channel cell area 122, 124 can only receive certain secondary channels. For example, wireless device 102 in primary channel cell area 122 is only capable of receiving secondary channels 111, 113. While wireless device 102 in primary channel cell area 124 is only capable of receiving secondary channels 115, 117. Although FIG. 1 depicts two secondary channels in each primary channel cell area, any number of secondary channels being received by wireless device 102 in primary channel cell area 122, 124 is within the scope of the invention. The number of secondary channels 111, 113, 115, 117 capable of being received in a given primary channel cell area 122, 124 is a function of topography, signal strength, atmospheric conditions, availability, and the like.

In an embodiment, secondary channel stations 110, 112, 114, 116 can be fed content from any number of secondary channel content providers 145. In addition, secondary channel content providers 145 can supply content elements corresponding to content broadcast by secondary channel stations 110, 112, 114, 116 to content matching system 104 as described more fully below.

In an embodiment, user profiles for communications system 100 can be set up via wireless device 102. In another embodiment, communications system 100 can include a user configuration device 147, such as a computer with an Internet connection using a web browser. User configuration device 147 can be used to set up user preferences with content matching system 104. For example, a user can log onto the Internet 146 in a manner generally known in the art and then access a configuration web page of the wireless device 102 and/or content matching system 104. Once the user has configured the web page selections as desired, he/she can submit the changes. The new configuration, data, preferences, and the like, including an updated user-profile, can then be transmitted to content matching system 104 and/or wireless device 102 via local node 106, 108.

Software blocks that perform embodiments of the invention are part of computer program modules comprising computer instructions, such as control algorithms, that are stored in a computer-readable medium such as memory described above. Computer instructions can instruct processors to perform methods of operating wireless device 102 and content matching system 104. In other embodiments, additional modules could be provided as needed. The components of communications system 100 shown in FIG. 1 are not limiting, and other configurations and components that form communications system 100 are within the scope of the invention.

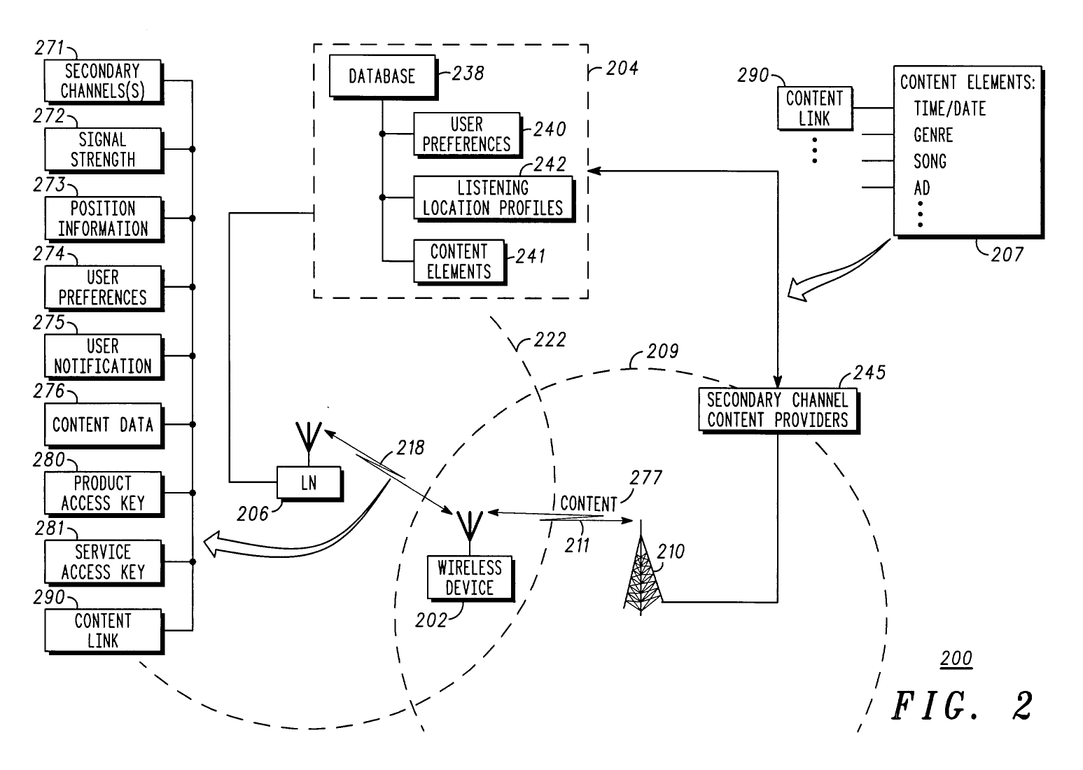

FIG. 2 is block diagram of a communications system 200 in accordance with another embodiment of the invention. As shown in FIG. 2, communications system 200 includes content matching system 204 of FIG. 1 with only the database 238 portions shown, wireless device 202 and secondary channel content providers 245.

In an embodiment, content matching system 204 collects content elements 207 from secondary channel content providers 245. Each content element 207 can correspond to a secondary channel 211 and content 277 broadcast on secondary channel 211. For example, content elements 207 can include a play-list of a particular secondary channel content provider, which represents what content 277 is going to be broadcast over a particular secondary channel 211 at a particular time and date. Content element can include artists, station genre, song, advertisement, product, time/date, radio frequency, and the like.

In an embodiment, content matching system 204 organizes content elements 207 into databases accessible using protocols such as Wireless Access Protocol (WAP), Voice Markup Language (VoxML), Hyper Text Markup Language (HTML), and the like. In an embodiment, each content element 207 can have a corresponding content link 290. Content link 290 can be, for example, a Uniform Resource Locator (URL) directing a user to a website where content data 276 can be accessed. In an embodiment, each content element 207 has its own content link 290. In another embodiment, content elements 207 can share a content link 290: Content data 276 can be corresponding to content element 207 and can include more information regarding a particular corresponding content element 207. Content data 276 can be supplied by secondary channel content provider 245, the manufacturer or service provider of a particular product or service, and the like.

Content matching system 204 can either “pull” content elements 207, or secondary channel content providers 245 can “push” content elements. Content elements 207 can be sent to content matching system 204 automatically at certain time intervals, or content matching system 204 can make periodic queries to secondary channel content providers 245 for updates to content elements 207. Content elements 207 can be stored in the content element database 241 of content matching system 204. Once content elements 207 are received by content matching system 204, they can be organized in content elements database 241 in any convenient method. For example, content elements 207 can be sorted by secondary channel 211, secondary channel station 210 genre, by song title, artist, advertising category, user of wireless device, and the like.

As shown in FIG. 2, when wireless device 202 is in primary channel cell area 222, wireless device 202 is capable of receiving content 277 broadcast over secondary channel 211. While only one secondary channel 211 is shown in FIG. 2, any number of secondary channels is within the scope of the invention. In an embodiment, wireless device 202 reports its position information 273, particularly its primary channel cell area 222, to content matching system 204, preferably using position application 156. Primary channel cell area 222 can correspond to a cell of a cellular phone network of one or more service providers, where service providers provide service for primary channel 218.

While in primary channel cell area 222, a user of wireless device 202 can create user preferences 274 for any particular type of content element 207 that would correspond to content 277 broadcast over secondary channel 211. For example, a user preference 274 can include a genre of secondary channel (news, sports, rock music, jazz, etc.), advertisements for particular products or services, artists, songs, and the like. Thereafter, content matching system 204 can match user preferences 274 to content elements 207. Upon matching user preferences 274 to content elements 207, content matching system 204 can transmit a user notification 275 to a user of wireless device 202 over primary channel 218 when content 277 broadcast over secondary channel 211 and corresponding content element 207 matches a user preference 274.

In an embodiment, a user can select a plurality of secondary channels 271 available in primary channel cell area 222. Wireless device 202 can scan all available secondary channels 211 while in primary channel cell area 222 and present a list to user on wireless device 202. Wireless device 202 can record the signal strength 272 of each secondary channel 211 in primary channel cell area 222. Signal strength 272 of secondary channel can be based on the range 209 of secondary channel 211. Also, the signal strength of primary signal 218 can be recorded as well. These can be uploaded to content matching system 204 via primary channel 218 and stored to indicate which secondary channels 211 are available in primary channel cell area 222 and their respective signal strengths 272.

As each secondary channel 211 is detected in primary channel cell area 222 by wireless device 202, a user can use wireless device 202 to “accept” or “reject” each station. The list of secondary channels 271 chosen by user for a particular location, preferably a primary channel cell area 222, can be a listening location profile 242. In an embodiment, a user can name a listening location profile 242 for a primary channel cell area 222. For example, a user might be located in a particular primary channel cell area 222 often, and name that listening location profile 242 “home.” In an embodiment, a user can any number of listening location profiles 242 for a given primary channel cell area 222, for example, “office,” “beach,” “jazz,” “rock,” and the like. In another embodiment, a user can create listening location profiles 242 for any location of wireless device 202.

In another embodiment, listening location profile 242 can be created utilizing a user configuration device 147 instead of wireless device 202. For example, a user can view a coverage map delineating primary channel cell areas 222 for wireless device 202, and create user preferences 274 and listening location profiles 242 with user configuration device 174 over the Internet 146 as opposed to using wireless device 202. In this embodiment, content matching system 204 can provide a list of secondary channels 211 available in primary channel cell area 222 based on input from wireless device 202 or other wireless devices. Listening location profiles 242 along with user preferences 274 created by a user via wireless device 202 or user configuration device 147 can be stored at content matching system 204 under a user's name, identification number, and the like. In this way, content matching system 204 can sort and match user preferences 274 and listening location profiles 242 to content elements 207 provided by secondary channel content providers 245.

In an embodiment, when content 277 is broadcast over secondary channel 211, whose corresponding content element 207 matches a user preference 274, a user notification 275 is transmitted to wireless device 202 via primary channel 218. In one embodiment, notifying the user over the primary channel 218 can include transmitting corresponding content link 290 associated with content element 207. In another embodiment, user notification 275 can include paging using any messaging protocol, for example SMSCB, and the like. In one embodiment, user notification 275 can include content having instructions to tune wireless device 202 to a given secondary channel 211. When user accesses content data 276, wireless device 202 automatically tunes to secondary channel 211. In yet another embodiment, user notification 275 of a match between user preference 274 and content element 207, user can forward this user notification 275 to another user instead of accessing content. If the other user accesses content, then the other user's wireless device will automatically tune to secondary channel 211. Using this feature, secondary channel content providers 245 can match advertisements and the like to specific users via user preferences 274 and thereby target and notify only interested users. Thereafter, interested users who elect to access content data 276 can have their wireless device automatically tuned to the secondary channel 211 where the advertisement is taking place.

Once user notification 275 is received, a user can access content data 276 corresponding to content element 207 on the primary channel 218 using the corresponding content link 290. In effect, primary channel 218 and listening location profile 242 are used to access content data 276 corresponding to content element 207. To illustrate, listening location profile 242 defines which secondary channels 211 are available to user on wireless device 202, while user notification 275 and accessing content data 276 occur over primary channel 218. In addition, one or more user preferences 274 can be used, since user preferences 274 can dictate which type of content 277 and content element 207 is matched to a user in content matching system 204.

In still another embodiment, when content 277 corresponding to content element 207 is broadcast over secondary channel 211, wireless device automatically tunes to secondary channel 211. For example, if a user preference 274 is for a certain song, and that song is broadcast over any secondary channel 211 in primary channel cell area 222 that is included in listening location profile 242, wireless device 202 can automatically tune secondary channel receiver module 150 to that secondary channel 211. In another embodiment, wireless device 202 is automatically tuned to secondary channel 211 if user accesses content data 276. In this embodiment, after user notification of a match between content element 207, content 277 being broadcast and a user preference 274, user can access content data 276 using content link 290. Thereafter, wireless device 202 is automatically tuned to secondary channel 211.

In still yet another embodiment, upon user accessing content data 276 over primary channel, content matching system 204 can transmit a content data product access key 280 and/or a content data service access key 281 to wireless device 202. Content data product access key 280 and content data service access key 281 can be electronic coupons entitling the user of wireless device 202 to a product or service related to content data 276. These are in effect an incentive for a user to access content data 276 to find out more about a product or service. For example, content data product access key 280 or service key 281 can be a bar code on the display of wireless device 202 entitling the user to a product or service at a given location that is related to content data (i.e. food samples, oil change, haircut, and the like).

In yet another embodiment, a user can select a listening location profile 242, even if the user is not located in the primary channel cell area 222 that corresponds to the listening location profile 242, and have content related to that listening location profile 242 sent via primary channel 218 to wireless device 202. Since listening location profile 242 is stored in listening location profile database 242 in content matching system 204, and wireless device 202 is requesting related content via primary channel 218, wireless device 202 does not have to be in a particular primary channel cell area 222 to receive content related to a listening location profile corresponding to that particular primary channel cell area 222.

In another embodiment, wireless device 202 can scan for any secondary channels 211 in primary channel cell area 222. Based on signal strength 272 of each of the secondary channels 211, content matching system 204 can select the appropriate listening location profile 242 from any of a plurality of listening location profiles. Thereafter, only those secondary channels 211 corresponding to the selected listening location profile 242 are made available on wireless device 202.

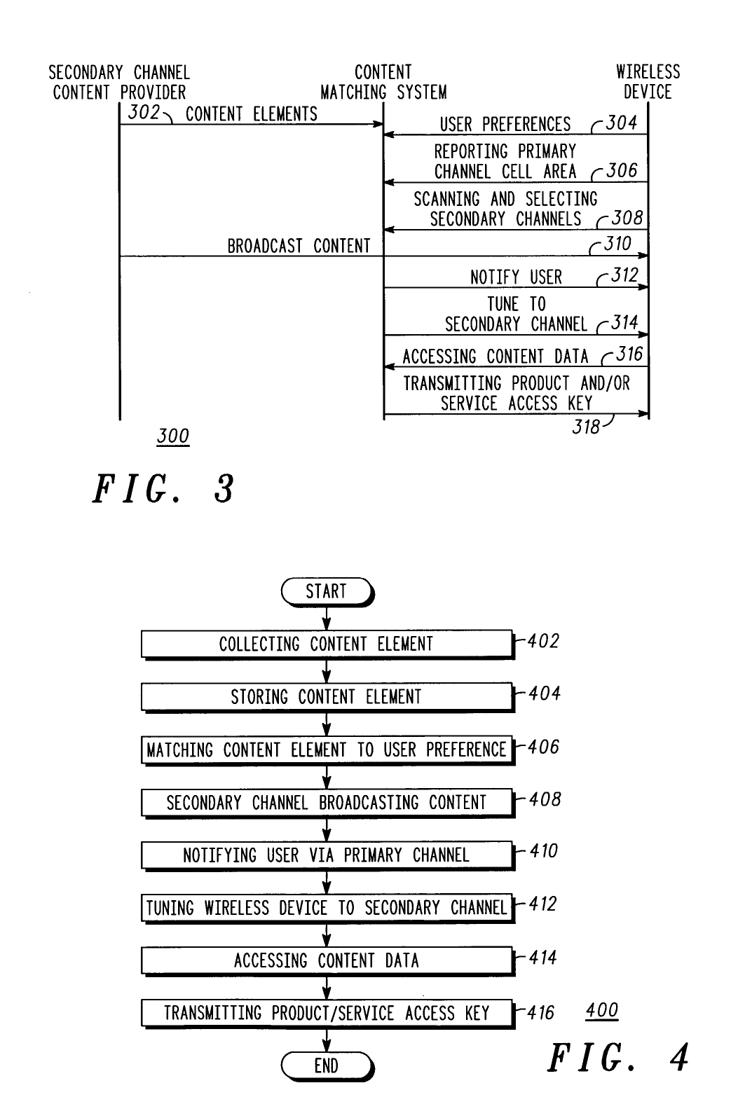

FIG. 3 is a ladder diagram 300 in accordance with an embodiment of the invention. As shown in FIG. 3, secondary channel content providers 245 send 302 content elements to content matching system 204. Content elements 207 can either be “pushed” to content matching system 204 or “pulled” (i.e. requested) to content matching system 204. Content elements can have a corresponding content link 290 and the frequency and instructions to tune to secondary channel 211.

User of wireless device 202 can input 304 user preferences 274, which are stored in content matching system 204. Also, wireless device 202 reports 306 its position information 273, particularly the primary channel cell area 222 to content matching system 204. Either automatically at certain time intervals or upon user request, wireless device 202 scans 308 secondary channels and the user can select desired channels for inclusion on a listening location profile 242. User can name the listening location profile 242, which corresponds to primary channel cell area 222. Listening location profile 242 is stored at content matching system 204.

Secondary channel content providers 245 can broadcast 310 content 277 to wireless device 202. Content matching system 204 notifies 312 user of a match between content element 207 and at least one user preference 274 by sending a user notification 275 over primary channel 218 to wireless device 202. User notification 275 can include a corresponding content link 290 to access content data 276 related to content element 207. Optionally, the user notification 275 can cause wireless device 202 to automatically tune 314 to secondary channel. User can then choose to access 316 content data 276 or forward notification to another user. If user chooses to access content data 276, content data product and/or service access keys can be transmitted 318 to wireless device 202 for use by user in purchasing or using products and/or services associated with content data 276.

Also, if user chooses to access content data 276, wireless device 202 can automatically be tuned to secondary channel 211.

FIG. 4 is a flow diagram 400 in accordance with an embodiment of the invention. In step 402, content matching system 204 collects content elements 207 from secondary channel content providers 245. In step 404, content elements 207 are stored in content matching system 204 along with user preferences 274 input by a user through either wireless device 202 or user configuration device 147. In step 406, content matching system 204 matches content element 207 to user preferences 274. Content 277 is broadcast over secondary channel 211 in step 408. In step 410, user is notified via primary channel of matches between content 277 and corresponding content element 207 with user preferences 274. Optionally, upon notification, wireless device 202 is automatically tuned to secondary channel 211 per step 412. In step 414, user can access content data 276 through wireless device 202. Optionally, content data product and/or service access keys are transmitted to wireless device 202.

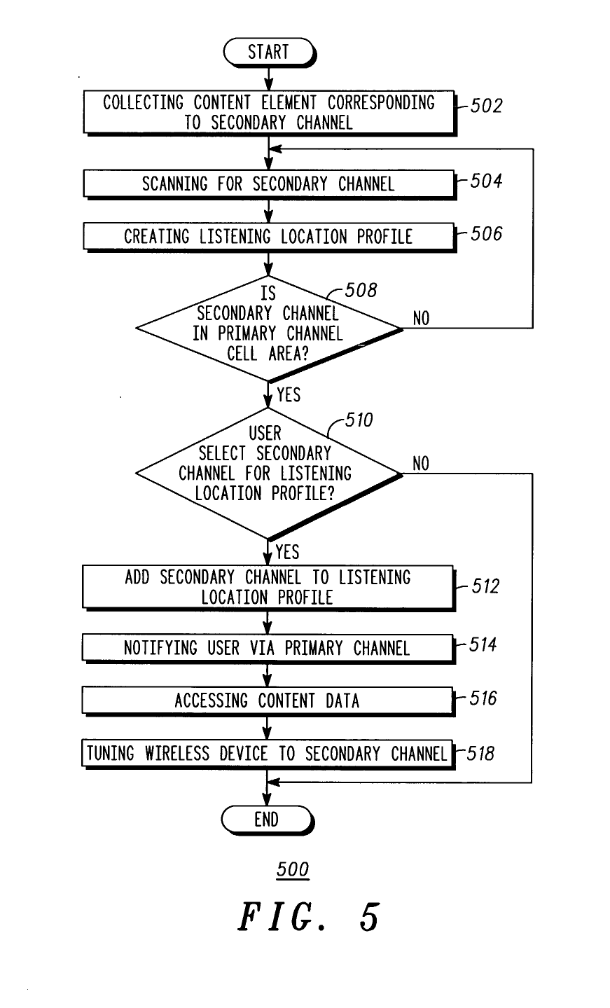

FIG. 5 is a flow diagram 500 in accordance with another embodiment of the invention. In step 502, content matching system 204 collects content elements 207 from secondary channel content providers 245. In step 504, wireless device 202 scans for secondary channels 211. In step 506, a user creates listening location profile 242, which corresponds to primary channel cell area 222. In step 508, it is determined if secondary channel 211 is receivable in primary channel cell area 222. Receivablility of secondary channel 211 can be based on topography, weather, range 209, and the like. If secondary channel 211 is receivable in primary channel cell area 222, then it is determined if a user selects secondary channel 211 for inclusion in listening location profile 242 in step 510. If so, then secondary channel 211 is added to listening location profile 242 and stored at content matching system 204 along with an identification means, such as a name, identification number, and the like per step 512. In an embodiment, the user can supply the name.

When content 277 is broadcast over secondary channel 211, whose corresponding content element 207 matches a user preference 274, a user notification 275 is sent via primary channel 218 to wireless device 202 per step 514. Content data 276 can then be accessed via primary channel 218 and wireless device 202 per step 516. Optionally in step 518, when content data 276 is accessed, wireless device 202 is automatically tuned to secondary channel 211 where content 277 is broadcast.

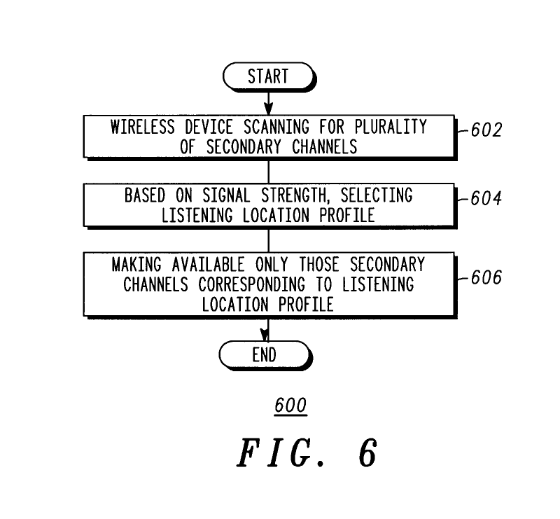

FIG. 6 is a flow diagram 600 in accordance with still another embodiment of the invention. In step 602, wireless device 202 scans, based on its current location in a primary channel cell area 222, for any of a plurality of secondary channels. In step 604, based on the signal strength 272 of each of the plurality of secondary channels detected and the position information 273 of wireless device 202, content matching system 204 selects a listening location profile 242 from any of a plurality of listening location profiles. Based on this selection, only those secondary channels corresponding to the chosen listening location profile are made available on wireless device 202.

While we have shown and described specific embodiments of the present invention, further modifications and improvements will occur to those skilled in the art. It is therefore to be understood that appended claims are intended to cover all such modifications and changes as fall within the true spirit and scope of the invention.

1. A method of accessing content data on a wireless device, comprising:
collecting a content element corresponding to a secondary channel and content broadcast on the secondary channel, and wherein the content element comprises a corresponding content link;
storing the content element in a database;
matching a user preference to the content element;
when the content corresponding to the content element is broadcast over the secondary channel, notifying a user of the wireless device via a primary channel; and
accessing the content data corresponding to the content element on the primary channel using the corresponding content link.

2. The method of claim 1, further comprising when the content corresponding to the content element is broadcast over secondary channel, tuning the wireless device to the secondary channel.

3. The method of claim 1, further comprising:
in a primary channel cell area, the wireless device scanning for a plurality of secondary channels;
creating a listening location profile;
selecting one or more of the plurality of secondary channels to be included in the listening location profile, wherein the listening location profile corresponds to the primary channel cell area;
storing the listening location profile; and
using the primary channel and the listening location profile to access the content data corresponding to the content element on any of the plurality of secondary channels in the listening location profile.

4. The method of claim 3, wherein using the primary channel and listening location profile to access content comprises using the primary channel, the listening location profile and the user preference to access the content data corresponding to the content element on any of the plurality of secondary channels in the listening location profile.

5. The method of claim 3, further comprising:
the wireless device scanning for the plurality of secondary channels;
based on a signal strength of each of the plurality of secondary channels, selecting the listening location profile from a plurality of listening location profiles; and
making available on the wireless device only those of the plurality of secondary channels corresponding to the listening location profile.

6. The method of claim 1, further comprising upon accessing content data, tuning the wireless device to the secondary channel.

7. The method of claim 1, further comprising upon accessing content data, transmitting one of a content data product access key and a content data service access key to the wireless device.

8. The method of claim 1, wherein notifying the user comprises sending the corresponding content link to the wireless device.

9. A method of accessing content data on a wireless device, comprising:
collecting a content element corresponding to a secondary channel and content broadcast on the secondary channel, and wherein the content element comprises a corresponding content link;
in a primary channel cell area, the wireless device scanning for the secondary channel;
creating a listening location profile;
selecting the secondary channel to be included in the listening location profile, wherein the listening location profile corresponds to the primary channel cell area;
storing the listening location profile; and
using a primary channel and the listening location profile to accesses the content data corresponding to the content element on the secondary channel in the listening location profile.

10. The method of claim 9, wherein using the primary channel and listening location profile to access content comprises using the primary channel, the listening location profile and a user preference to access the content data corresponding to the content element on the secondary channel in the listening location profile.

11. The method of claim 9, further comprising upon accessing content data, tuning the wireless device to the secondary channel.

12. The method of claim 9, further comprising upon accessing content data, transmitting one of a content data product access key and a content data service access key to the wireless device.

13. The method of claim 9, further comprising when the content corresponding to the content element is broadcast over secondary channel, notifying a user of the wireless device via the primary channel.

14. The method of claim 13, wherein notifying the user comprises sending the corresponding content link to the wireless device.

15. A method of accessing content data on a wireless device, comprising:
collecting a content element corresponding to a secondary channel and content broadcast on the secondary channel, and wherein the content element comprises a corresponding content link;
matching a user preference to the content element;
in a primary channel cell area, the wireless device scanning for the secondary channel;
creating a listening location profile;
selecting the secondary channel to be included in the listening location profile, wherein the listening location profile corresponds to the primary channel cell area;
storing the listening location profile; and
using a primary channel, the listening location profile and the user preference to access the content data corresponding to the content element on the secondary channel in the listening location profile.

16. The method of claim 15, further comprising upon accessing content data, tuning the wireless device to the secondary channel.

17. The method of claim 15, further comprising upon accessing content data, transmitting one of a content data product access key and a content data service access key to the wireless device.

18. The method of claim 15, further comprising when the content corresponding to the content element is broadcast over secondary channel, notifying a user of the wireless device via the primary channel.

19. The method of claim 18, wherein notifying the user comprises sending the corresponding content link to the wireless device.

20. A computer-readable medium containing computer instructions for instructing a processor to perform a method of accessing content data on a wireless device, the instructions comprising:
collecting a content element corresponding to a secondary channel and content broadcast on the secondary channel, and wherein the content element comprises a corresponding content link;
storing the content element in a database;
matching a user preference to the content element;
when the content corresponding to the content element is broadcast over the secondary channel, notifying a user of the wireless device via a primary channel; and
accessing the content data corresponding to the content element on the primary channel using the corresponding content link.

21. A computer-readable medium containing computer instructions for instructing a processor to perform a method of accessing content data on a wireless device, the instructions comprising:
collecting a content element corresponding to a secondary channel and content broadcast on the secondary channel, and wherein the content element comprises a corresponding content link;
in a primary channel cell area, the wireless device scanning for the secondary channel;
creating a listening location profile;
selecting the secondary channel to be included in the listening location profile, wherein the listening location profile corresponds to the primary channel cell area;
storing the listening location profile; and
using the primary channel and the listening location profile to accesses the content data corresponding to the content element on the secondary channel in the listening location profile.
